(19) United States
(12) Patent Application Publication
(10) Pub. No.: US 2015/0111182 A1
(43) Pub. Date: Apr. 23, 2015

(54) Reusable Magnetic Letters, Numbers, and Shapes

(71) Applicant: Sonya Janine Nelson, Mentone, CA (US)

(72) Inventor: Sonya Janine Nelson, Mentone, CA (US)

(21) Appl. No.: 14/058,265

(22) Filed: Oct. 20, 2013

(51) Int. Cl. G09B 19/00

(52) U.S. Cl. CPC G09B 19/00
USPC 434/167

(57) ABSTRACT

These magnetic, write-on/wipe-off letters, numbers, and geometric shapes enable a child to learn to write and spell quickly. Primarily, they are individual pieces that are packaged as a set and have a grooved write-on/wipe-off surface with a magnetic base, so as to adhere to any magnetic surface enabling them to be manipulated quickly and easily, which will accelerate the process of learning to write and spell.

### BACKGROUND OF THE INVENTION

1. Field of Invention

This invention relates to teaching aids, and more particularly to magnetic letters, numbers, and shapes with a write-on/wipe-off surface. These magnetic letters, numbers, and shapes are packaged as a set, and enable a child to learn to write quickly by providing a grooved outline which is covered by a smooth, flexible plastic making it possible to receive the tip of a dry erase marker or crayon, without penetrating the surface. The child traces the letter, number or shape, using the grooves as a guide, with a dry erase marker or erasable crayon, and then just wipes it off, giving the child the benefit of repeated practice. This invention is particularly helpful for children with fine motor skill impairments and very young children. The letters, numbers, and shapes are magnetic so that they are stable and will not move around when the child is writing on them. They can be stuck to any magnetic surface, but are meant to be used with a magnetic dry erase board so the child can then practice writing without the magnetic letters, numbers and shapes onto the dry erase board itself. The magnetic letters, numbers and shapes are individual pieces so that they can be manipulated easily in order to assist in the spelling and reading process.

2. Description of Prior Art

One prior art writing training device of the type in which the proper manner of writing is mastered by tracing a guide with a writing tool is the traditional stencil. A stencil is as thin sheet of material, such as paper, plastic, or metal, with letters or a design cut from it, used to produce the letters or design on an underlying surface by applying pigment through the cut-out holes in the material.

A first drawback is that since the stencil must be placed onto a piece of paper or other writing surface, letters and numbers such as a, b, p, d, 8 9 and 0 cannot be made with one continuous stroke. The stencil must have a small break where the pencil stops the child must then lift the pencil and place it on the other side of the break, disrupting the flow of the writing process.

The second drawback is that during the process of learning to write and spell, the child must find the appropriate letter stencil, line it up with the last letter, trace it, and then find next letter, line it up, etc. This is a cumbersome, time consuming process which disrupts the flow of learning to write and spell.

The third drawback is that the stencil must used with an underlying surface which can usually only be used once and then thrown away. This is an unnecessary waste of money and natural resources.

Finally, the fourth drawback is that the stencil must be held in place with the other hand while the child use it. This is also cumbersome, and if the stencil is not held firmly, it slips, and the image is not formed correctly. Therefore, the child will soon get bored, so that sufficient training cannot be obtained.

### SUMMARY OF THE INVENTION

The principal object of this invention is to provide grooved, magnetic letters, numbers and shapes with a write-on/wipe-off surface, which will help to develop a child's fine motor skills while teaching them to properly form the letters, numbers and shapes.

Another object of this invention is to provide magnetic letters, numbers, and shapes that can be placed individually on a magnetic surface so that the child can manipulate them quickly, which will enable the child to not only learn to write, but also will accelerate the process of learning to read and spell.

A further object of this invention is to provide individual letters, which are designed to hold a child's attention and encourage them to want to learn to write, spell, and read.

A still further object of this invention is to provide a writing training device, which can he used repeatedly, providing the benefit of sufficient practice to master the ability to form the letters correctly.

### BRIEF DESCRIPTION OF THE DRAWINGS

FIG. 1 is a front perspective view of a letter character of the present invention;

FIG. 2 is a rear perspective view of FIG. 1;

FIG. 3 is a perspective view of the construction of FIG. 1;

FIG. 4 is a perspective view of the present invention shown in operative use;

### DESCRIPTION OF PREFERRED EMBODIMENTS

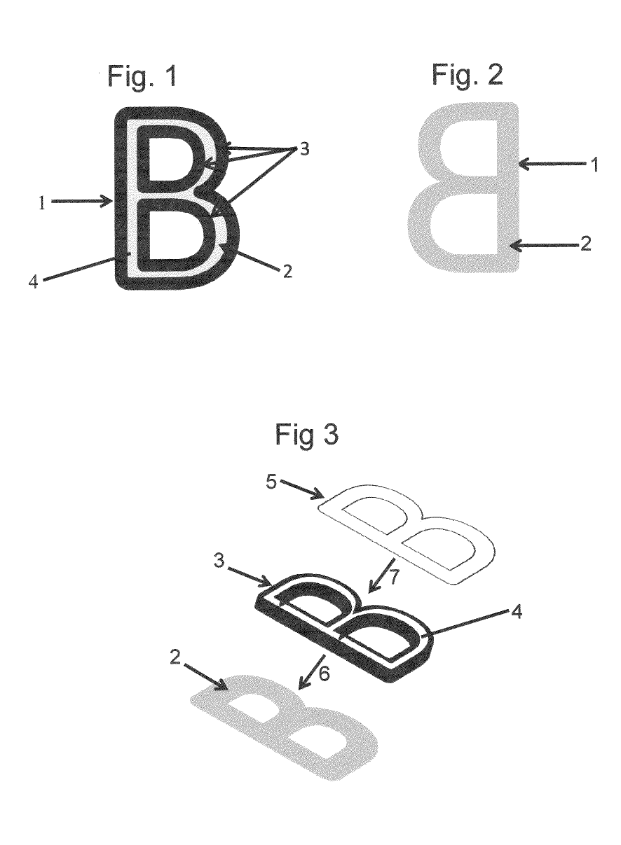

FIGS. 1 and 2 illustrate the front and rear view of a letter-character shaped piece 1 of present invention, shown to have a flat body, having geometrically centered grooves 4 which is created by using 0.022″ or thicker raised chipboard, hard plastic, wood, or metal outline 3. Outline 3 is then covered with a clear polyethylene, cellophane, or other plastic 5, which forms a smooth, flexible, write-on/wipe off surface over the grooves for guiding a scribing instrument, such as a dry-erase marker, or crayon 9, so as to trace piece 1 and then wipe it clean. FIG. 2 illustrates the rear view magnetic base 2 of the letter-character 1, which enables piece 1 to adhere to any magnetic surface.

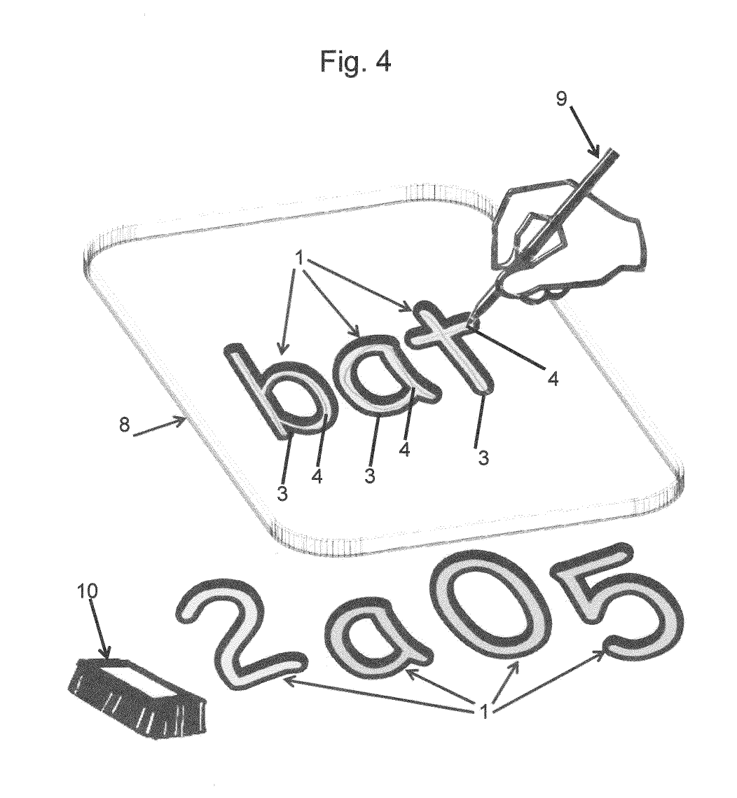

FIG. 3 illustrates the construction of letter-character shaped piece 1. Raised outline 3 is adhered 6 to the top of magnetic piece 2, magnetic piece 2 is 020″ or 0.030″ flexible magnetic sheeting. Clear plastic 5, is then adhered 7 to the top of raised outline 3, creating a flexible write-on/wipe-off surface, enabling scribing tool 9, to trace piece 1 using the grooves 4 as a guide.

FIG. 4 a plurality of geometric, numbers, and letter character-shaped pieces 1, in operative use. Piece 1 is shown being used on magnetic dry erase board 8, dry-erase marker 9 is used to trace piece 1, within the grooves 4 of outline 3, which is covered by plastic 5. Marker 9 is then wiped off with eraser 10, Letter character-shaped pieces 1 may also be manipulated to aid in the process of learning to read and spell.

While various changes may be made in the detail construction, it is understood that such changes will be within the spirit and scope of the present invention, as is defined by the appended claims.

What I claim is:

1. A plurality of letters, numbers, and geometric shaped pieces for use by a child as an aid in learning to write, spell, and read comprising individual pieces constructed of flexible magnetic sheeting which forms the base, a raised outline of the same piece is then adhered to the magnetic base, forming a grooved outline which is then covered with a clear plastic sheet, creating a smooth, flexible surface capable of receiving the tip of a dry erase marker or crayon, without penetrating the surface so that marker or crayon can be wiped off easily, enabling the pieces to be used repeatedly, providing unlimited amount of practice in forming letters, numbers, and shapes correctly.
